(19) United States
(12) Patent Application Publication
(10) Pub. No.: US 2006/0264566 A1
(43) Pub. Date: Nov. 23, 2006

(54) HCR room temperature curable rubber composition

(75) Inventors: Susan Cassar, Tecumseh, MI (US); Nicholas Babicky, Ann Arbor, MI (US)

Correspondence Address: BROOKS KUSHMAN P.C., 1000 TOWN CENTER, TWENTY-SECOND FLOOR, SOUTHFIELD, MI, 48075, US

(73) Assignee: Wacker Chemical Corporation, Adrian, MI (US)

(21) Appl. No.: 11/132,966

(22) Filed: May 19, 2005

(51) Int. Cl. C08L 83/04; C08K 3/10

(52) U.S. Cl. 524/588; 524/437; 525/478

(57) ABSTRACT

A low temperature curable silicone rubber composition includes a polysiloxane mixture, a platinum group metal containing catalyst, an inhibitor, a crosslinker, and an alumina powder mixture in an amount of at least 85% of the weight of the curable silicone rubber composition. The alumina powder mixture of the invention includes two or more micronized alumina powders, and in particular, three micronized alumina powders. Advantageously, the silicone rubber compositions of the invention are curable at room temperature with both excellent calenderability and thermal conductivity thereby making these compositions excellent candidate materials for forming gap pads.

### BACKGROUND OF THE INVENTION

1. Field of the Invention

The present invention is related to low temperature curable silicone rubber compositions that cure into high thermal conductivity rubbers.

2. Background Art

High thermal conductivity rubbers are used in a number of heat sink constructions to provide conformal contact to electrical components that are to be protected from heat damage. An important example of such a construction is the “gap pad” which provides a thermal interface between heat sinks and electronic devices.

Gap pads are particularly useful when uneven surface topography, air gaps and rough surface textures are present in the component to be protected. Gap pads are used in a number of different applications which include telecommunications, computer and peripherals, and power conversion. In these applications, the gap pad may be placed between heat generating semiconductors and a heat sink, in an area where heat needs to be transferred to a frame, chassis, or other type of heat spreader, and between heat generating magnetic components and a heat sink.

The rubbery nature of a gap pad allows for a high conformability to reduce interfacial resistance. For example, air gaps are eliminated thereby reducing thermal resistance. Moreover, the rubbery nature of the gap pad simultaneously allows for low-stress vibration dampening. It is also desirable that gap pad materials possess machinability and calenderablity (pressable into sheets) to be formed into the variety of shapes. Finally, gap pads also require long term chemical and thermal stability equal to at least the expected life of the component being protected. A variety of rubber and plastic compositions are used to form a gap pad. Silicone compositions in particular have been found useful due to the well known chemical and thermal stability of silicone rubber compositions.

Although the prior art methods for forming high thermal conductivity rubbers work reasonably well, improvements are needed in both the conductivity and in the material processing characteristics of the rubbers formed by such processes. For example, the need to form the rubber into a variety of shapes when used in gap pad applications require that the cured rubber be both calenderable and machinable. Moreover, economics always dictate that these components be as inexpensive as possible without sacrificing quality. Many of the prior art methods for forming gap pads involve processes in which a silicone rubber composition is cured at elevated temperatures, thereby, adding cost to the price of the rubber. Moreover, such compositions often produce rubbers with suboptimal machinability and thermal conductivity.

Accordingly, there exists a need for improved rubber compositions for use in gap pad applications that are curable at room temperature with improved machinability and high thermal conductivity.

### SUMMARY OF THE INVENTION

The present invention solves one or more problems of the prior art by providing in one embodiment a low temperature curable silicone rubber composition. The low temperature curable silicone rubber composition of the invention includes a polysiloxane mixture, a platinum group metal containing a platinum group metal containing catalyst, an inhibitor, a crosslinker, and an alumina powder mixture in an amount of at least 85% of the weight of the curable silicone rubber composition. The alumina powder mixture of the invention includes two or more micronized alumina powders. Advantageously, the silicone rubber compositions of the invention are curable at room temperature with excellent calenderability, thermal conductivity, and softness thereby making these compositions excellent candidate materials for forming gap pads.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventor.

The term “polysiloxane” as used herein refers to polymers whose backbones consist of alternating atoms of silicone and oxygen with organic substituents attached to the silicon atoms.

The term “silicone gum” as used herein refers to polydiorganosiloxanes with high molecular masses. Typically such gums will have molecular masses between 100,000 and 500,000 and a viscosity greater than about 1,000,000 centipoise.

The term “silicone fluids” as used herein refers to organopolysiloxanes having a viscosity in the range from 0.65 to 1,000,000 centipoise at 25°.

The term “mid viscosity” as used herein means a viscosity in the range between 500 to 50,000 centipoise at 25°.

The term “low viscosity” as used herein means a viscosity in the range from 0.65 to 500 centipoise at 25°.

The term “micronized” as used herein refers to a material which is in a powder form. Typically, such powders have average particle sizes (i.e., diameters when the particles are spherical) on the order of about 1 micron to about 500 microns.

In an embodiment of the present invention, a low temperature curable silicone rubber composition is provided. The low temperature curable silicone rubber composition of the invention includes a polysiloxane mixture, a platinum group metal containing catalyst, an inhibitor, a crosslinker, and an alumina powder mixture in an amount of at least 85% of the weight of the curable silicone rubber composition. Unless specifically stated, all percentages are weight percentages of the total weight of the low temperature curable silicone rubber composition. The low temperature curable silicone rubber composition includes high levels of the alumina powder mixture in order to achieve the high conductivity of the cured rubber. The high filler loading and the high viscosity of the material contributes to the calenderability of the rubber composition. Specifically, the rubber composition is calendered into a predetermined shape prior to being cured into a cured rubber. This predetermined shape advantageously has a consistent thickness (i.e., substantially uniform thickness). In one variation the predetermined shape is a sheet with consistent thickness. The silicone rubber composition of the invention typically cures into rubber having a thermal conductivity greater than about 1.0 watts/meter-° K. (“W/m-K”) measured at 100° C. In some variations, the silicone rubber composition of the invention cures into rubber having a thermal conductivity from about 1.0 W/m-K to about 3.0 W/m-K measured at 100° C. In still other variations of the invention, the silicone rubber composition of the invention typically cures into rubber having a thermal conductivity from about 1.5 W/m-K to about 2.0 W/m-K measured at 100° C.

As set forth above, the alumina powder mixture is present in a high weight proportion. The alumina powder mixture is present in order of increasing preference in an amount of at least 85 wt %, 86 wt %, 87 wt %, 88 wt %, 89 wt %, and 90 wt % of the weight of the curable silicone rubber composition. In another variation of the invention the alumina powder mixture is present in order of increasing preference in an amount less than or equal to 95 wt %, 94 wt %, 93 wt %, 92 wt %, 91 wt %, and 90 wt % of the weight of the curable silicone rubber composition (all weight percentages are the weight percent of the low temperature curable composition).

The alumina powder mixture used in the invention includes two or more micronized alumina powders. Examples of useful alumina powders are the AS powders available from Showa Denko KK in Japan, the AO line of alumina powder available from Admatechs, and the DAW and SFP lines of powders available from Denka located in Japan. Typically, the alumina powder mixture comprises from about 30 wt % to about 60 wt % (of the total weight of the rubber composition) of a first micronized alumina powder having an average volume less than or equal to about 5×10⁻⁹ cm³ and about 30 wt. % to about 60 wt % (of the total weight of the rubber composition) of a second micronized alumina powder having an average particle volume greater than about 5×10⁻⁹ cm³. In a refinement of the invention, the first micronized alumina powder has an average particle volume from about 1×10⁻¹² cm³ to 5×10⁻⁹ cm³ and the second micronized alumina powder has an average particle volume from about 5×10⁻⁹ cm³ to about 5×10⁻⁶ cm³. In a further refinement of the invention, the first micronized alumina powder has an average particle volume from about 5×10⁻¹¹ cm³ to 5×10⁻⁹ cm³ and the second micronized alumina powder has an average particle volume from about 2.5×10⁻⁹ cm³ to about 5×10⁻⁷ cm³. In an important variation of the invention, the alumina mixture further comprises a third micronized alumina powder. Typically, this third alumina powder is present in an amount from about 0.5 wt percent to about 20 wt percent of the total weight of the rubber composition and an average volume less than about 2.5×10⁻¹¹ cm³. The first, second, and third micronized alumina particles can be of virtually any shape, though spherical powders are particularly preferred. When the first, second, and third micronized powders are substantially spherical each is also characterizable by the average diameters of the particles. Typically, the first micronized alumina powder has an average diameter from about 1 to about 20 microns, the second micronized alumina powder has an average diameter from about 20 to about 100 microns, and the third micronized alumina powder has an average diameter from about 0.1 to about 2microns.

The alumina powder mixture of the invention is further characterized in that each of the first, second, and third micronized powders are in situ treated with an organosilane compound, and in particular, an alkyl silane during incorporation into the rubber composition. Suitable alkylsilanes, include, for example, isooctyl trimethoxysilane; tetraethoxysilane; methyltrimethoxysilane; methyltriethoxysilane; n-propyltriethoxysilane; isopropyltrimethoxysilane; octyltriethoxysilane; isooctyltrimethoxysilane; hexadecyltrimethoxysilane; octadecyltrichlorosilane; vinyltrimethoxysilane; vinyltriethoxysilane; vinyltris(methoxyethoxy)silane; 3-methacryloxypropyltrimethoxy-silane; 3-methacryloxypropyltriethoxysilane; organochlorosilanes such as methyltrichlorosilane, dimethyldichlorosilane, octyltrichlorosilane, and trimethyl monochlorosilane; cycloalkylsilanes such as cyclohexyltrimethoxysilane, cyclopentyltrichlorosilane, cyclohexyltriethoxysilane; cycloalkenylsilanes such as cyclohexenylethyltriethoxysilane, and cyclododecadienyl-trichlorosilane, and cyclooctenyltimethoxysilane. In a particularly useful variation, the alumina powder mixture is treated with isooctyl trimethoxysilane.

The silicone rubber composition of the invention includes a polysiloxane mixture. In a variation of the invention, the polysiloxane mixture includes organohydrogenpolysiloxanes and a polyorganic polysiloxanes. In a further refinement, the organohydrogenpolysiloxane has an average composition described by formula 1:
(R³)_{c} (H)_{d} SiO_{(4-c-d)/2} 1
wherein R³ is an unsubstituted or substituted alkyl, c is a number greater than 0 and less than or equal to 3, d is a number greater than 0 and less than or equal to 2, with the proviso that the sum of c and d is less than 4. Typically, the organohydrogenpolysiloxane is present in an amount from about 0.5% to about 20% of the total weight of the silicone rubber composition. In some variations, the organohydrogenpolysiloxane is present in an amount from about 1% to about 15% of the total weight of the silicone rubber composition. In still other variations, organohydrogenpolysiloxane is present in an amount from about 4% to about 10% of the total weight of the silicone rubber composition. Examples of organohydrogenpolysiloxanes include both crosslinkers and chain extenders.

The polysiloxane mixture of the invention also includes a polyorganic polysiloxane. In a variation of the invention, the polysiloxane mixture includes a low viscosity vinyl-terminated dimethyl silicone fluid and a vinyl-terminated dimethyl silicone gum. The low viscosity vinyl-terminated dimethyl silicone fluid typically has a viscosity less than about 500 centipoise at 25° C. In a variation of the invention, the low viscosity vinyl-terminated dimethyl silicone fluid has a viscosity from about 10 to about 500 centipoise at 25°. In another variation of the invention, the low viscosity vinyl-terminated dimethyl silicone fluid has a viscosity from about 50 to about 400 centipoise at 25°. In yet another variation of the invention, the low viscosity vinyl-terminated dimethyl silicone fluid has a viscosity from about 100 to about 300 centipoise at 25°. Typically, the polyorganic polysiloxane is present in an amount from about 0.5% to about 10% of the total weight of the silicone rubber composition. In some variations of the invention, the polyorganic polysiloxane is present in an amount from about 0.5% to about 5% of the total weight of the silicone rubber composition. In still other variations, the polyorganic polysiloxane is present in an amount from about 1% to about 3% of the total weight of the silicone rubber composition. In a further refinement of the invention, the polyorganic polysiloxane is described by formula 2 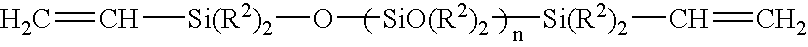
wherein R² is a substituted or unsubstituted alkyl and n is an integer. In a variation of this embodiment, n is an integer from 0 to 3000.

As set forth above, the polyorganic siloxane furthers as an inhibitor in variations of the invention. When an inhibitor is used, the inhibitor is typically present in an amount from about 0.001% to about 1% of the total weight of the silicone rubber composition. In other variations, the inhibitor is present in an amount from about 0.005% to about 0.5% of the total weight of the silicone rubber composition. In still other variations, the inhibitor is present in an amount from about 0.01% to about 0.3% of the total weight of the silicone rubber composition. The inhibitor is present in a sufficient amount to adjust the cure time of the rubber composition with a temperature range of about 20° C. to about 50° C. In a variation of the invention, the inhibitor is present in a sufficient amount to adjust the cure time of the rubber composition with a temperature range of about 20° C. to about 30° C. In another embodiment of the invention, the inhibitor is in a sufficient amount to set the cure temperature of the rubber composition to the temperature range to about 25° C. (i.e., room temperature). Examples of inhibitors include compounds including ethynyl groups or acetylenic groups. A particularly useful inhibitor is ethynyl cyclohexanol and in particular, ethynyl cyclohexanol in vinyl polymer silicone fluid.

The polymerization of the silicone rubber composition of the invention is catalyzed by conventional addition reaction platinum group metal-containing catalysts. The platinum group metals that may be used in the present invention include platinum, rhodium, ruthenium, palladium, osmium and iridium. In most applications, the platinum group metal is platinum because of platinum's high activity in hydrosilylation reactions. Typically, the platinum group metal-containing catalyst is present in an amount from about 0.001% to about 1% of the total weight of the silicone rubber composition. In other variations, the platinum group metal-containing catalyst is present in an amount from about 0.001% to about 0.5% of the total weight of the silicone rubber composition. In still other variations, the platinum group metal-containing catalyst is present in an amount from about 0.005% to about 0.2% of the total weight of the silicone rubber composition. Suitable catalysts include the platinum group metal in any number of chemical states. The catalyst may include a platinum group metal, a compound containing a platinum group metal, or a microencapsulated platinum group metal-containing catalyst. Examples include particulate platinum adsorbed on carriers such as silica, alumina and silica gel, by platinum black, platinum supported on activated carbon, platinum chloride, chloroplatinic acid, complexes of chloroplatinic acid hexahydrate with olefins or divinyldimethylpolysiloxane, platinum-olefin complexes, platinum-alkenylsiloxane complexes, alcohol solutions of chloroplatinic acid hexahydrate, palladium catalysts, and rhodium catalysts.

The silicone rubber composition of the invention also includes one or more crosslinkers. Typically, the crosslinker is present in an amount from about 0.001% to about 2% of the total weight of the silicone rubber composition. In other variations, the crosslinker is present in an amount from about 0.005% to about 1% of the total weight of the silicone rubber composition. In still other variations, the crosslinker is present in an amount from about 0.01% to about 0.5% of the total weight of the silicone rubber composition. Examples of crosslinkers that may be used in this embodiment include organohydrogenpolysiloxanes. A particularly useful crosslinker is dimethyl-methyl hydrogen silicone fluid.

The silicone rubber composition can comprise additional ingredients, provided the ingredient does not prevent the composition from curing at room temperature with sufficient machinability and calenderability. Such additional ingredients include, for example, dyes, pigments, adhesion promoters, anti-oxidants, heat stabilizers, UV stabilizers, flame retardants, flow control additives, reactive diluents, and the like.

The silicone rubber composition of the invention is made by mixing the components in any equipment capable of mixing high viscosity materials (such as a sigma blade or centrifugal mixer). For example, the gum components are charged in a mixer, a portion of the alumina powder mixture (containing all sizes) is then added. The remaining fluid components are then added to the mixer and mixed until homogenous. Additional portions of the alumina powder mixture are added followed by mixing until homogenous. The catalyst is incorporated equipment that does not generate excessive heat like a two-roll mill. The composition is then immediately processed into a desired shape. Material will cure at room temperature in a time frame determined by catalyst and inhibitor levels.

The following examples illustrate the various embodiments of the present invention. Those skilled in the art will recognize many variations that are within the spirit of the present invention and scope of the claims.

Table 1 provides silicone rubber compositions made in accordance with the invention. The amounts provided in Tables 1 are relative weights.

TABLE 1
Low temperature curable silicone rubber compositions.

| Component | Example 1 | Example 2 | Example 3 |
|---|---|---|---|
| AS 50 | 39 | | |
| AS 10 | 39 | | |
| AO 502 | 9.8 | | |
| DAW 45 | | 52 | 52 |
| DAW 05 | | 35 | 34 |
| AM SFP | | 1 | 2 |
| vinyl terminated dimethyl silicone | 7 | 6.8 | 6.8 |
| gum | | | |
| mid viscosity hydrogen terminated | 2 | 2 | 2 |
| dimethyl silicone fluid | | | |
| low viscosity vinyl terminated | 2 | 2 | 2 |
| dimethyl silicone fluid | | | |
| isooctyl trimethoxylsilane | 0.4 | 0.4 | 0.4 |
| 4% ethynyl cyclohexanol in vinyl | 0.1 | 0.1 | 0.1 |
| polymer silicone fluid | | | |
| dimethyl-methyl hydrogen silicone | 0.6 | 0.6 | 0.6 |
| fluid | | | |
| organoplatinum complex in | 0.1 | 0.1 | 0.1 |
| silicone fluid | | | |

With reference to Table 2, the thermal conductivities and durometer measurements (Shore OO) performed in accordance to ASTM D224 are provided. The data in Table 2 shows that the silicone rubber compositions of the invention form cured rubbers with sufficient thermal conductivity (greater that 1.0 W/m-K) and softness to be used in gap pad applications.

TABLE 2
Thermal conductivities and Durometer measurements of the silicone
rubber compositions of the invention.

| | Example 1 | Example 2 | Example 3 |
|---|---|---|---|
| Thermal conductivity | 1.8 | 1.8 | 1.8 |
| (watts/meter-° K) | | | |
| Durometer | 84 | 80 | 86 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A low temperature curable silicone rubber composition comprising:
a polysiloxane mixture, the polysiloxane mixture including
polyorganic polysiloxane;
organohydrogenpolysiloxane;
a platinum group metal containing catalyst;
a crosslinker, and
a alumina powder mixture in an amount of at least 85% of the weight of the curable silicone rubber composition, the alumina powder mixture comprising two or more micronized alumina powders.

2. The silicone rubber composition of claim 1 wherein the alumina powder mixture is present in an amount of at least 88% of the weight of the curable silicone rubber composition.

3. The silicone rubber composition of claim 1 wherein the alumina powder mixture comprises from about 30 wt. % to about 60 wt % of a first micronized alumina powder having an average volume less than or equal to about 5×10⁻⁹ cm³ and about 30 wt. % to about 60 wt % of an second micronized alumina powder having an average volume greater than about 5×10⁻⁹ cm³.

4. The silicone rubber composition of claim 3 wherein the alumina mixture further comprises from about 0.5 wt percent to about 20 wt percent of a third spherical alumina powder having an average volume less than about 2.5×10⁻¹¹ cm³.

5. The silicone rubber composition of claim 4 wherein the first, second, and third micronized alumina powders are treated with an organosilane compound.

6. The silicone rubber composition of claim 5 wherein the first, second, and third micronized alumina powders each independently include alumina particles that are substantially spherical.

7. The silicone rubber composition of claim 6 wherein the first micronized alumina powder has an average diameter of about 10 microns, the second micronized alumina powder has an average diameter of about 37 microns, and the third micronized alumina powder has an average diameter of about 0.6 microns.

8. The silicone rubber composition of claim 1 wherein the polysiloxane mixture further comprises an inhibitor and a chain extender.

9. The silicone rubber composition of claim 8 wherein:
the organohydrogen polysiloxane is present in an amount from about 0.5 to about 10% of the total weight of the silicone rubber composition;
the polyorganic polysiloxane is present in an amount from about 1% to about 20% of the total weight of the silicone rubber composition;
the platinum-based catalyst is present in an amount from about 0.001 to about 1% of the total weight of the silicone rubber composition;
the inhibitor is present in an amount from about 0.001 to about 1% of the total weight of the silicone rubber composition; and
the crosslinker is present in an amount from about 0.001 to about 2% of the total weight of the silicone rubber composition.

10. The silicone rubber composition of claim 1 wherein the polyorganic polysiloxane comprises one or more components described by formula 2: 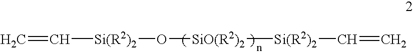
wherein R² is a substituted or unsubstituted alkyl and n is an integer.

11. The silicone rubber composition of claim 9 wherein the polyorganic polysiloxane comprises a low viscosity vinyl-terminated dimethyl silicone fluid and a vinyl-terminated dimethyl silicone gum.

12. The silicone rubber of claim 1 wherein the organohydrogenpolysiloxane has an average composition described by formula 1:
(R³)_{c} (H)_{d} SiO_{(4-c-d)/2} 1
wherein R³ is an unsubstituted or substituted alkyl, c is a number greater than 0 and less than or equal to 3, d is a number greater than 0 and less than or equal to 2, with the proviso that the sum of c and d is less than 4.

13. The silicone rubber composition of claim 1 wherein the polysiloxane mixture is a mid-viscosity hydrogen-terminated dimethyl silicone fluid.

14. The silicone rubber composition of claim 1 wherein the platinum-based catalyst comprise a platinum group metal, a compound containing a platinum group metal, or a microencapsulated platinum group metal-containing catalyst.

15. The silicone rubber composition of claim 1 wherein the inhibitor comprises an ethynyl cyclohexanol in vinyl polymer silicone fluid.

16. The silicone rubber composition of claim 1 wherein crosslinker comprises dimethyl-methyl hydrogen silicone fluid.

17. A cured rubber formed by calendering the silicone rubber composition of claim 1 into a predetermined shape of consistent thickness prior to curing.

18. A low temperature curable silicone rubber composition comprising:
a polysiloxane mixture, the polysiloxane mixture including:
polyorganic polysiloxanes; and
organohydrogenpolysiloxane;
a platinum-based catalyst;
an inhibitor;
a crosslinker, and
an alumina powder mixture including:
a first micronized alumina powder in an amount from about 30 wt. % to about 60 wt % of the weight of the alumina powder mixture, the first micronized alumina powder comprising a plurality of substantially spherical particles having an average volume less than or equal to about 5×10⁻⁹ cm³;
a second micronized alumina powder in an amount from about 30 wt. % to about 60 wt % of the weight of the alumina powder mixture, the second micronized alumina powder comprising a plurality of substantially spherical particles having an average volume greater than about 5×10⁻⁹ cm³; and
a third micronized alumina powder in an amount of about 0.5 wt percent to about 20 wt percent of the weight of the alumina powder mixture, the third micronized powder comprising a plurality of substantially spherical particles having an average volume less than about 2.5×10⁻¹¹ cm³.

19. The silicone rubber composition of claim 18 wherein the organohydrogenpolysiloxane has an average composition described by formula 1:
(R³)_{c} (H)_{d} SiO_{(4-c-d)/2} 1
wherein R³ is an unsubstituted or substituted alkyl, c is a number greater than 0 and less than or equal to 3, d is a number greater than 0 and less than or equal to 2, with the proviso that the sum of c and d is less than 4.

20. The silicone rubber composition of claim 18 wherein the polyorganic polysiloxane comprises one or more components described by formula 2: 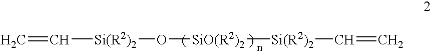
wherein R² is a substituted or unsubstituted alkyl and n is an integer.

21. The silicone rubber composition of claim 18 wherein the platinum-based catalyst comprise a platinum group metal, a compound containing a platinum group metal, or a microencapsulated platinum group metal-containing catalyst.

22. A low temperature curable silicone rubber composition comprising:
a polyorganic polysiloxane;
a organohydrogenpolysiloxane;
a platinum-based catalyst;
an inhibitor;
a crosslinker, and
an alumina powder mixture including:
a first micronized alumina powder in an amount from about 30 wt. % to about 60 wt % of the weight of the alumina powder mixture, the first micronized alumina powder comprising a plurality of substantially spherical particles having an average diameter from about 1 to about 20 microns;
a second micronized alumina powder in an amount from about 30 wt. % to about 60 wt % of the weight of the alumina powder mixture, the second micronized alumina powder comprising a plurality of substantially spherical particles having an average diameter from about 20 to about 100 microns; and
a third micronized alumina powder in an amount of about 0.5 wt percent to about 20 wt percent of the weight of the alumina powder mixture, the third micronized powder comprising a plurality of substantially spherical particles having an average diameter from about 0.1 to about 2 microns.
